(19) United States
(12) Patent Application Publication
(10) Pub. No.: US 2024/0156146 A1
(43) Pub. Date: May 16, 2024

(54) PATTY-FORMING APPARATUS WITH A SPLITTABLE MOLD FOR MOLDING NON-FLUID STICKY MINCES

(71) Applicant: Sergey Logunov, Tver (RU)

(72) Inventor: Sergey Logunov, Tver (RU)

(21) Appl. No.: 18/055,704

(22) Filed: Nov. 15, 2022

(51) Int. Cl. A23P 30/10

(52) U.S. Cl. CPC A23P 30/10

(57) ABSTRACT

Invention is a patty-forming apparatus with an innovative mold. The mold is a plate which has cavities for molding products in shape of cylindrical holes with base of arbitrary shape, and it also has a distinctive feature that there is a cut in the plate which goes through these holes and which allows to move plate parts apart in the directions parallel to the plate surface. The two parts of the plate are separated when the mold is being filled with mince, and then are connected for molding the product. The technical results are: possibility to mold well shaped products from minces with very poor fluidity and reduced energy cost of molding.

### PRIOR DISCLOSURES BY THE INVENTOR

The given invention has been granted patent of the Russian Federation 2774416 (Filing Date 11/16/2021, application number 2021133321, official governmental publication link https://www.fips.ruiregisters-doc-viewgips_servlet?DB=RUPAT&DocNumber=2774416&TypeFile=html).

### TECHNICAL FIELD THE INVENTION RELATES TO

The invention relates to food industry, specifically to the machines designed to mold food products from various non-fluid pastes or minces, for example patties, rissoles, Japanese cheesecakes, etc.

### PRIOR ART, BACKGROUND OF THE INVENTION

Beginning the middle of the XXth century, highly efficient automated machines for molding patties and other similar products became widespread.

The most popular of them are models in which dosing of mince and simultaneous molding is done by filling cavities in a thick plate made from firm material with mince. The plate can be flat or can be a drum wall. Despite these machines have wide varieties in their components, they all have common principles in their design and functioning which might be described as follows.

Such a machine has:
1. Container for mince
2. Pumping device
3. Mold which is either a firm flat plate or a drum wall with one or more holes in it
4. One or more ejectors for shaped products. Ejectors are usually pistons which can move through the holes of the mold.

During the process of molding, the pumping device is forcing mince from the mince container to the holes of the mold. The pressure created by the pumping device is forcing the mince to fill all the inner volume of the mold holes, and thus ensuring the mince is dosed by volume and having same shape as the mold holes.

Countless models of patty-forming machines are based on this principle due to its efficiency and simplicity. But this principle of design and functioning can be improved further in a certain way.

It is well known to engineers working in food rheology, that minces, depending on ingredients and technologies used to mince, may have different grades of fluidity and thus be closer to liquids or solids in its characteristics.

It is necessary for the proper functioning of a machine of the described type that the pressure created by the pumping device must be distributed near uniformly in all directions inside the mince. Only in this case the mince forced by the pumping device to the cavities in the mold, will evenly fill all the space inside the cavity.

The ability of transmitting pressure equally in all directions is a distinctive feature of liquids and is the reason why they flow. However, if a mince is closer to wet sand in its characteristics, then the pressure created by the pumping device on the mince, will not make the mince fill mold cavities evenly, no matter how strong the pressure is.

To be able to use patty-forming machines of the type described above, food technologists have to put significant efforts into developing mince recipes specifically for this molding principle, the recipes unusable with this principle are rejected.

The reason the author came up with the invention was the necessity of molding products from mince with very poor fluidity (mince similar to wet sand). For instance, minces made from raw firm vegetables and having big enough particles.

### SUMMARY OF THE INVENTION

To make possible molding products from minces with very low fluidity, the following changes to the principle and functioning of the machine are made. The plate, which has holes for molding, is cut into two parts. Holes for molding are placed along the cut line. If a geometrical shape of the bottom of the hole is axially symmetric, then the axis of symmetry should coincide with the cut line or be close to it. In the simplest case, when the bottom shape of a cylindrical hole is a disk, the cut lines should pass through centers of the circles.

When the mold cavities are to be filled with mince, the two parts of the plate are moved in the opposite directions from the cut line and thus allowing enough space for mince to come in.

Mince can be fed at very low pressure, even under gravity solely, because the pressure of the mince feeding in this case is not used to mold the product. Then the plate parts become connected again. When the two parts of the plate move towards one another, they act like bulldozer's blades, raking the mince and filling all parts of the cavities with it.

A pumping device in this case becomes unnecessary. To be precise, compressing the mince inside cavities of a mold, which usually is a part of a pumping device's functionality, is in our case done by the moving parts of the mold itself. The other part of a pumping device's job, which is moving the mince towards mold cavities, can be done by gravity, if the mince container is placed right above the mold and is funnel-shaped. Other options to move mince toward the mold may be belt, scraper or vibratory conveyor.

The present forming machine has considerably lower energy consumption, since energy loss on moving all the mince under significant pressure is eliminated.

Without using a pumping device the mince entering the space between the two disconnected parts of the mold may be loose and non-compacted, it may come as separated clods with empty space between them, but this is not a problem.

If the mold parts are pulled apart far enough from each other, then there is certainly enough mince in the cavities when the parts are moved towards each other, and the mince becomes compacted, while the excessive mince is extruded back to the mince container. Another way to collect enough mince between the mold parts is not by increasing the distance between them when they are disconnected, but disconnecting and connecting the mold parts two or more times during the same product molding cycle. Each time the mold parts are pulled apart, some mince is added to the space between them.

### BRIEF DESCRIPTION OF THE DRAWINGS

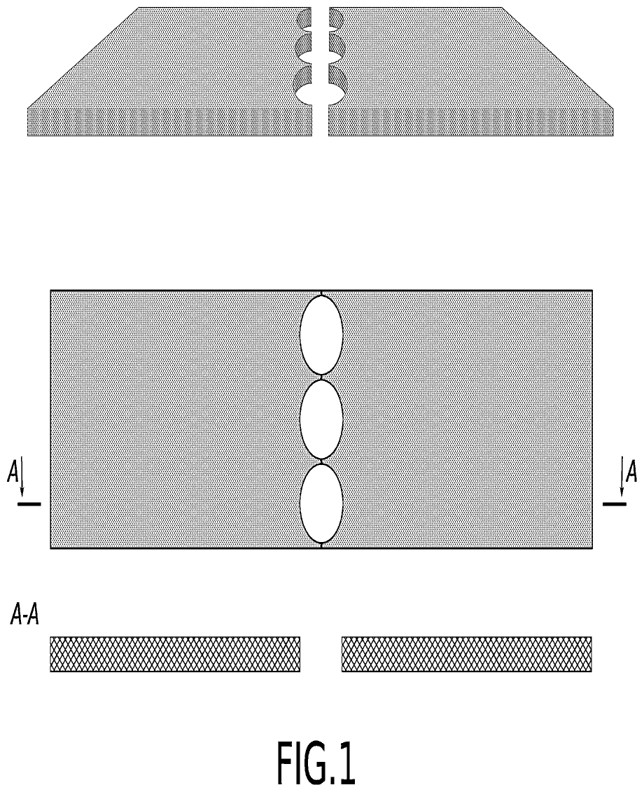

Drawing on FIG. 1 contains sequentially from top to bottom:
a) One of the possible mold plate shapes with the two parts disconnected
b) Same mold plate top view with its two parts connected
c) Section view of the plate mentioned in paragraph b), the cut is made along A-A line.
   Similar sections are used in all the following drawings, which illustrate functioning of possible machines based on the invention.

The following drawings represent section views of three possible machines designed upon the invention's principle. The views show phases of the cycle repeated by the machine to mold products.

Drawings on Figures from 2 to 5 show the schematic section views of the simplest machine with flat mold plate described in the section “Simplest Model with a flat Molding Plate” of the chapter “Detailed Description and Mode of Operation”.

Drawings on Figures from 6 to 9 show the schematic section views of the more complex machine with flat mold plate described in the section “Complex Model with a flat Molding Plate” of the chapter “Detailed Description and Mode of Operation”.

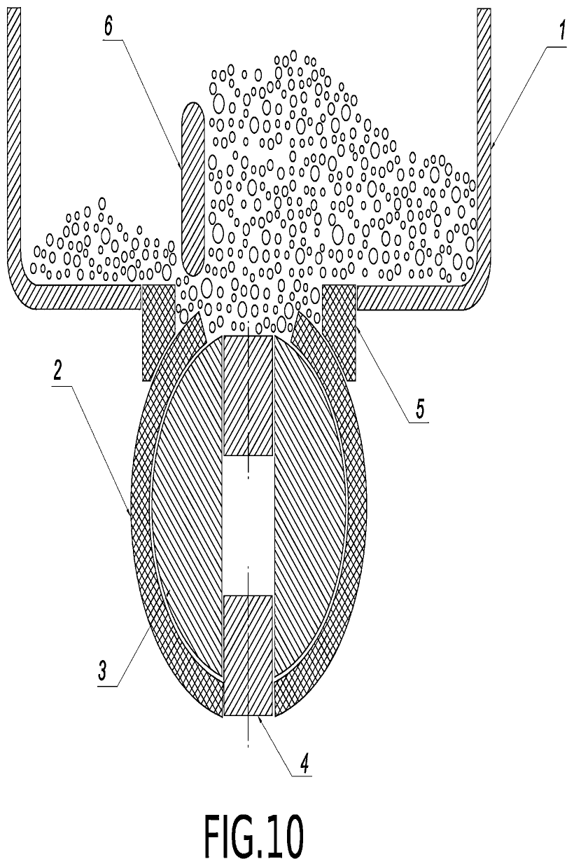

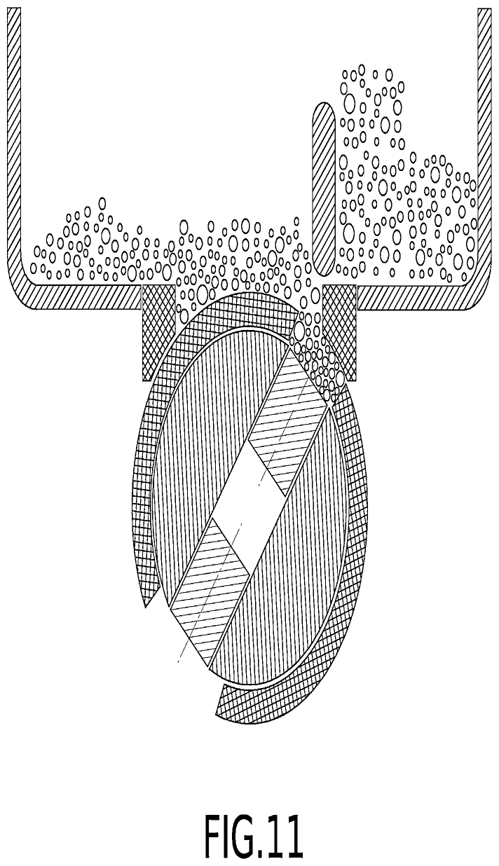

Drawings on FIGS. 10 and 11 show the schematic section views of the machine with a molding plate shaped as a drum wall, described in the section “Model with a Molding Plate shaped as a Drum Wall” of the chapter “Detailed Description and Mode of Operation”.

### DETAILED DESCRIPTION AND MODE OF OPERATION

Three embodiments of the invention are listed below:
1) One of the simplest models with a flat molding plate, not allowing to change product weight by simple adjustment of the machine
2) More complex model with a flat molding plate, enabling product weight adjustments during the production process, including automated adjustments
3) Model with a molding plate shaped as a drum wall, which is similar in design to the Formatic range of machines from Deighton Manufacturing (UK).

Let us describe design and operating of each embodiment with the help of the drawings, starting from the simplest model.

Simplest Model with a flat Molding Plate

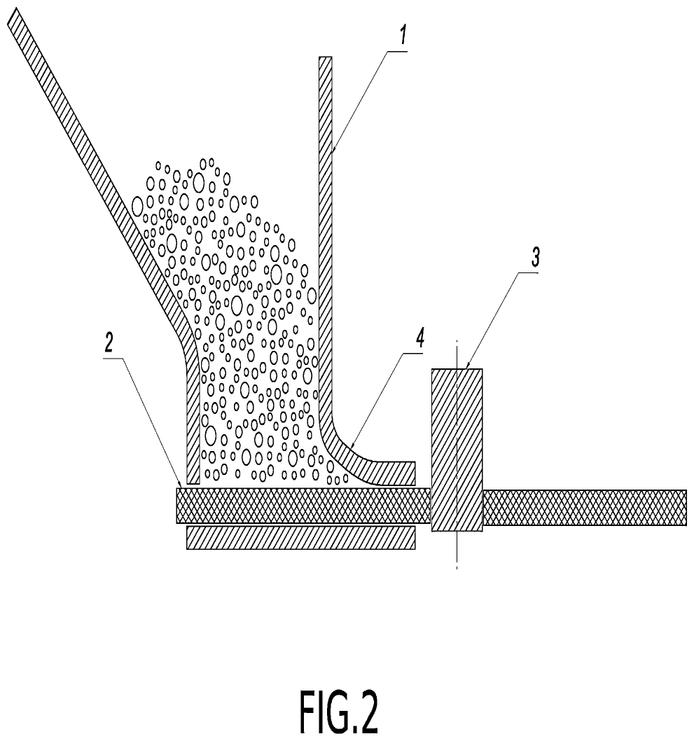

In FIG. 2, there are numbered:
1— The mince container expanding upwards. There are slits in the right and in the left walls of the container near its bottom. The parts of the mold go through these slits and slide along the container's flat bottom.
2— The splittable molding plate with molding holes shaped as circular cylinders. Section view shows the cut through centers of these cylinders, as shown in FIG. 1.
3— The piston for ejecting molded product out of the mold.
4— The part of the mince container, which can be called a compacting camera.

FIG. 2 shows the initial phase of the molding cycle. Molding of the previous product is completed, and this product is ejected by the piston, which has moved down through the cylinder hole in the plate.

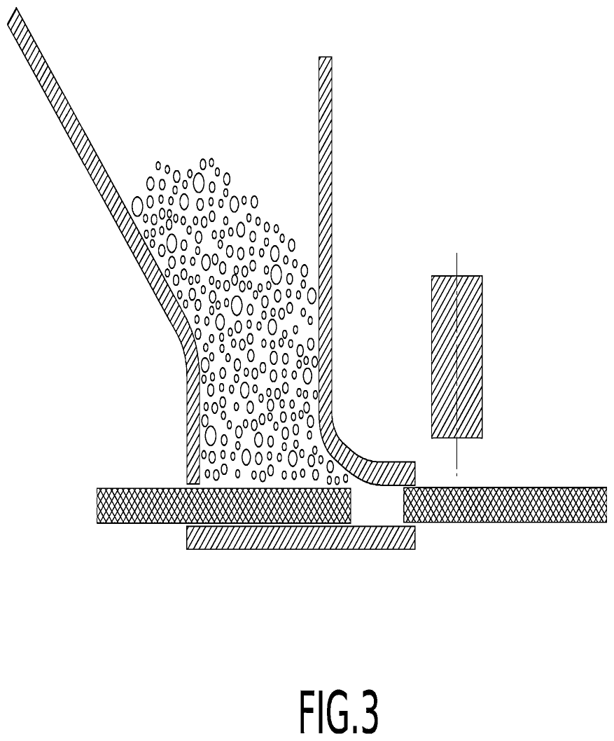

FIG. 3 shows the next phase of the cycle: ejecting piston went up to its initial position, and molding plate's parts are moving to the left.

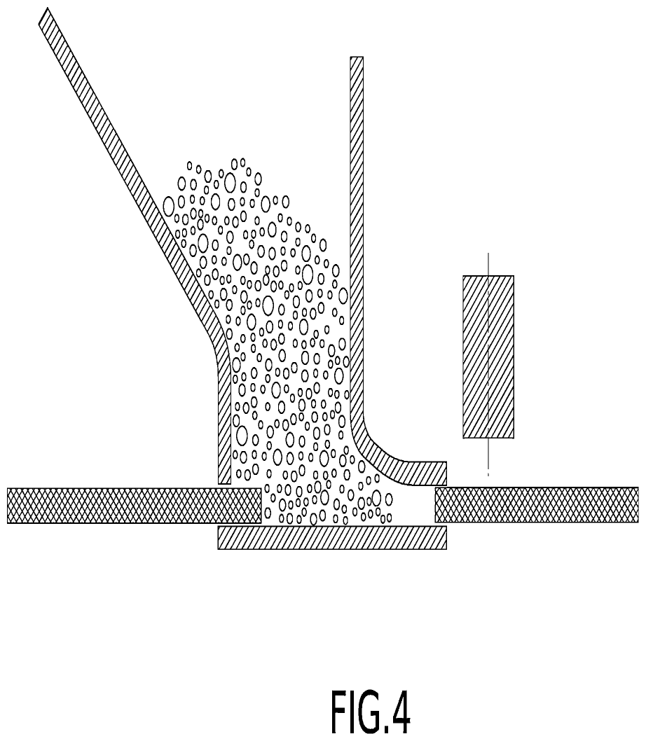

FIG. 4 depicts the third phase of the cycle. The left part of the plate keeps moving to the left, while the right part has stopped, so that molding cavity is inside the compacting camera, and non-compacted mince drops down to the space between the two parts of the plate under gravity.

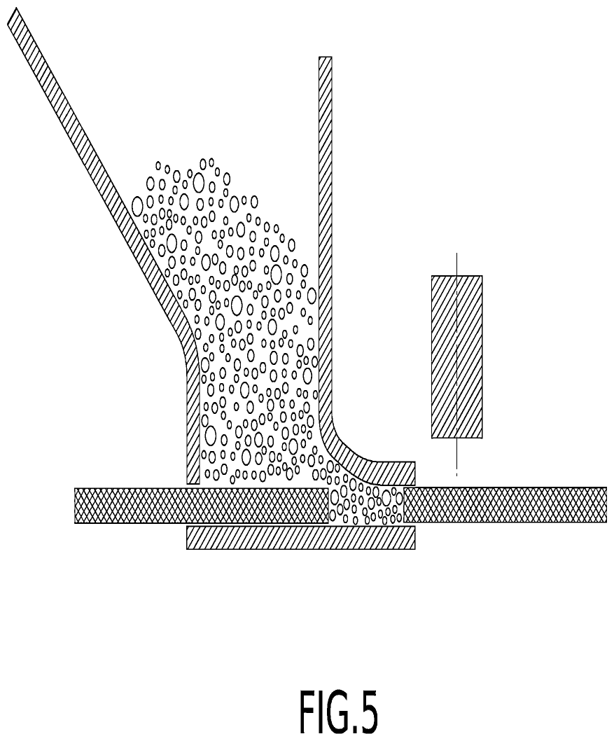

FIG. 5 depicts the final phase of the cycle: The left part of the plate is moving to the right, while the right part is fixed firmly in the previous position. The mince is being compacted between the plate parts, and excessive mince is being extruded back to the mince container through a channel between the left edge of the molding cavity and the left elevated surface part of the compacting camera.

In the machine variant described above the mince fills all the volume of the molding cavity, so product's weight can not be altered without modifying mince's density or replacing the plates. A minor modification to the machine allows easy adjustments of the weight of the molded product.

Complex Model with a flat Molding Plate

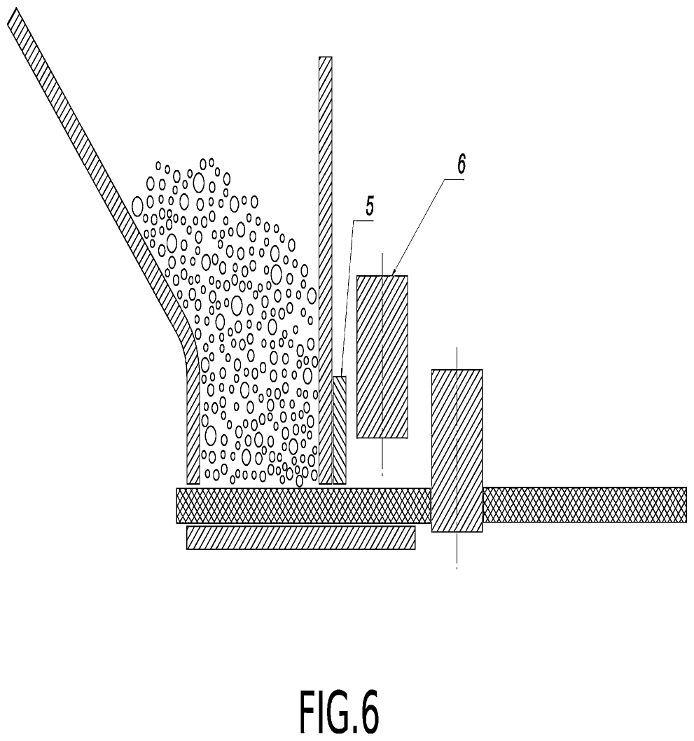

FIG. 6 depicts the initial cycle phase of the modified machine. The machine design has the following alterations:

a) Mince container has no compacting camera
b) The right slit of the container has a gate valve 5, which can move up and down c) One more row of pistons added (6), sized to go tightly inside the mold holes, similar to ejecting pistons.

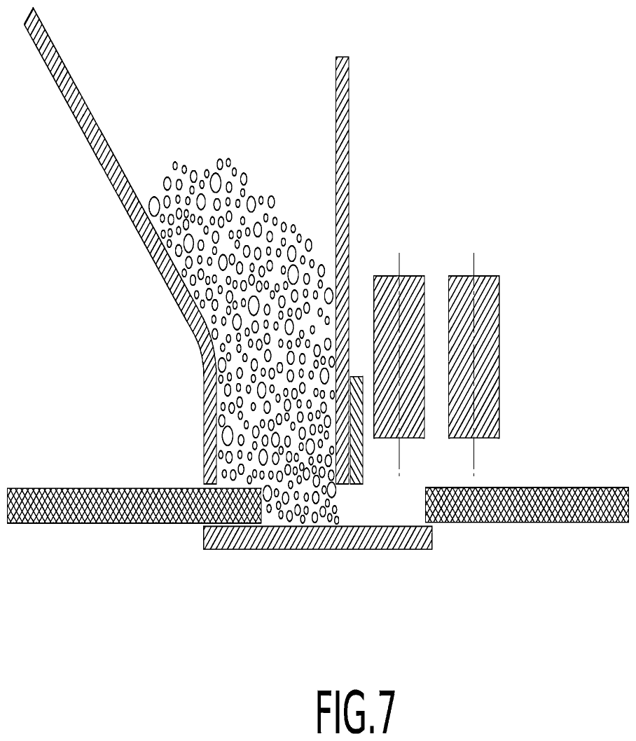

FIG. 7 shows the next phase of the cycle: ejecting piston is up in the initial position, the plate parts are moving to the left, during that, the right part stopped near the right side of the container, and the left part is continuing its movement further to the left.

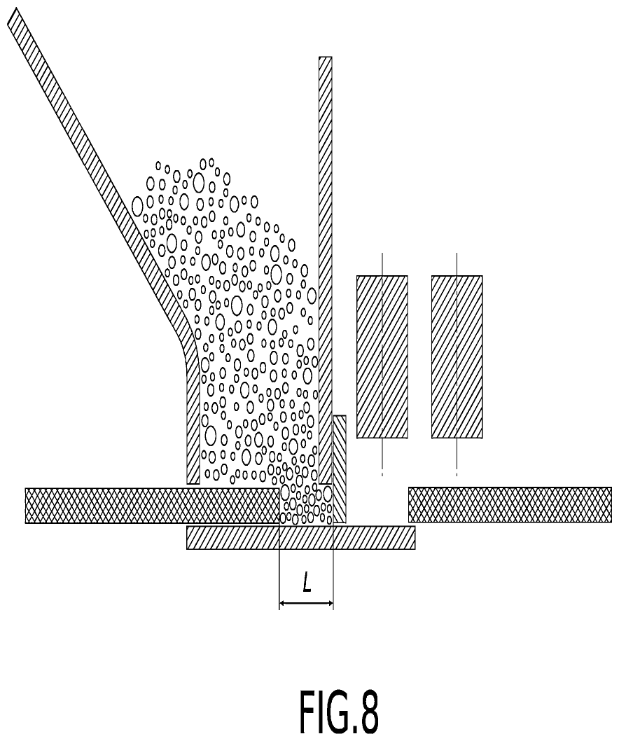

FIG. 8 depicts the third phase of the cycle: the gate valve is down, the left part of the plate starts moving right towards the valve, at this time the valve and the plate produce the zone of uniformly compacted mince between them. The excessive mince is extruded upward from the space between the valve and the left edge of the molding cavity. The plate stops when it reaches a certain predefined distance L between the left edge of the molding cavity and the valve.

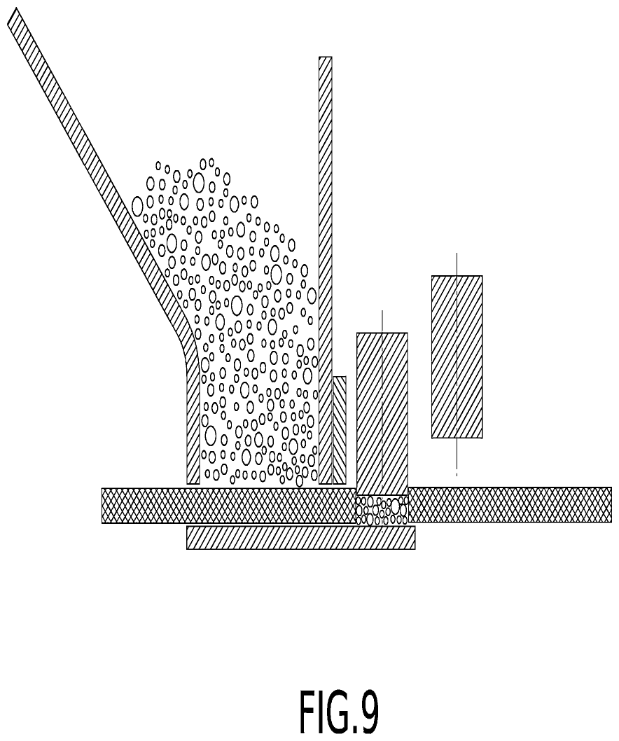

FIG. 9 illustrates the final phase of the cycle: the valve goes up, the compacted layer of mince is pushed by the left edge of the plate rightward out from the container, until the two parts of the plate connect. The upper layer of mince inside the molding cavity is being leveled and pressed by the additional piston. The molding is completed, and the machine returns to the initial phase of the cycle illustrated by FIG. 6.

The described machine variation allows the cavity to be filled with mince partially; the volume of mince coming to the cavity depends on distance L in the third phase of the cycle. This distance can be adjusted easily, for an example, by setting up quantity of pulses, which are sent to the stepper motor driving the left part of the plate. This allows, in particular, an automated adjustment of the product molded.

Now let us consider an invention embodiment with the molding plate in form of a drum wall. Designs of such kind are most widespread among the patty-forming machines of low capacity.

Model with a Molding Plate shaped as a Drum Wall

In FIG. 10, there are numbered:
1— The cylindrical mince container. The section is made by the plane passing through the middle between the container's axis and its wall.
2— The molding plate, consisting of two identical units. Each unit is a part of the drum wall. These units could be made in the following way. At first the drum is cut into two halves along its axis, then a narrow strip is cut off along one of the cut lines from each of the halves. As a result each unit is slightly smaller than a half of the drum. Let us call “the end faces” the surfaces appeared as a result of the cuts. If one connects the two units with any of the end faces, then there is a gap between the other two end faces. Finally recesses have to be made on each of the end faces so that they would form molding cavities when the end faces are connected, similarly to the case with a flat molding plate depicted on FIG. 1. The molding plate parts are completely symmetrical, so when a couple of end faces meet and form molding cavity(-ies), the other couple of end faces is disconnected, and vice versa.
3— The rotating cylinder, to which the molding plate parts adjoin. Every part of molding plate can slide over the cylinder's surface. (The cylinder and each part of the plate rotate independently around the cylinder's axis).
4— The piston for ejecting molded product.
5— The supply neck, which tightly connects the molding plate to the hole in the mince container.
6— The stirring blade, rotating around the axis of the cylindrical mince container. In Formatic range of machines from Deighton Manufacturing (UK) and in other similar patty-forming machines they install the blades at an angle from the rotation axis, because the agitator also serves as a pumping device there. In our case the agitator does not have to force the mince to the supply neck under pressure, so the blades are allowed to be parallel to the axis (i. e. be vertically oriented).

FIG. 10 illustrates the initial phase of the molding cycle. The end faces are connected in the lower part of the cylinder. In this lower part, the molding of the product has just been finished and the product has been ejected with the piston, which had moved through the cavity of the plate. On the upper side of the cylinder the end faces are disconnected, and the mince is dropping to the space between them from the supply neck. The presence of mince above the supply neck at this moment is ensured by the agitator blade, rotating in sync with the cylinder.

FIG. 11 represents the next molding cycle phase. The cylinder has been rotated 45 degrees clockwise. The lower piston has moved back towards the cylinder's axis. The molding plate parts are disconnected in the lower part of the cylinder and connected on the upper side. The proper portion of the mince is gathered in the upper cavity and squeezed by the meeting mold parts, while the excessive mince is being extruded back to the supply neck. To return to the initial phase, the cylinder and the molding plate have to make a 135-degrees turn clockwise, and the piston has to eject the next product.

The design examples described above are illustrative, the possible invention implementations are not limited to these examples.

1. An apparatus for molding food product from non-fluid sticky minces, comprising:
a) a container for mince;
b) a firm flat or configured as a part of drum wall mold plate with at least one molding cavity;
c) at least one piston for shaped products ejecting,
characterized in that,
d) there is a cut in the mold plate which goes through the molding cavities and which allows to move the parts of the plate apart in the directions parallel to the plate surface, during that the mince come in to the space between the separated plate parts from the container;
e) connecting of the plate parts is performed at least once in every molding cycle with a force sufficient to move and compact the mince in the molding cavities.
